(19) United States
(12) Patent Application Publication
(10) Pub. No.: US 2003/0197980 A1
(43) Pub. Date: Oct. 23, 2003

(54) Voice coil motor with shielded coil portion

(76) Inventors: Yiren Hong, Singapore (SG); TakKoon Ooi, Singapore (SG); ChorShan Cheng, Singapore (SG); YongJie Tang, Singapore (SG)

Correspondence Address: Derek J. Berger, Seagate Technology LLC, Intellectual Property - COL2LGL, 389 Disc Drive, Longmont, CO, 80501, US

(21) Appl. No.: 10/302,265

(22) Filed: Nov. 22, 2002

Related U.S. Application Data
(60) Provisional application No. 60/374,078, filed on Apr. 18, 2002.

(51) Int. Cl. G11B 5/55

(52) U.S. Cl. 360/264.7

(57) ABSTRACT

A voice coil motor suitable for use in devices where space is a significant constraint. The voice coil motor includes one coil portion intersectable with a magnetic field to produce resultant forces and an opposing coil portion shielded from the magnetic field such that the opposing coil portion does not intersect with the magnetic field.

### CROSS REFERENCE TO RELATED APPLICATION

This application claims the benefit of U.S. Provisional Application No. 60/374,078, filed Apr. 18, 2002.

### FIELD OF THE INVENTION

The present invention relates generally to electromagnetically actuated apparatus. More particularly, the present invention relates to an improved voice coil motor.

### BACKGROUND OF THE INVENTION

Voice coil motors are useful for providing controllable motion. One practical application of voice coil motors can be found in data storage devices where a voice coil motor is used for controllably positioning read/write heads with respect to storage media.

While various voice coil motors have been proposed in the past, there remains a need to provide a voice coil motor with improved torque at reduced cost. Other considerations that may determine the commercial utility of a voice coil motor include ease of manufacture and assembly.

The present invention provides a solution to this and other problems, and offers other advantages over the prior art.

### SUMMARY OF THE INVENTION

The present invention relates to a voice coil motor suitable for use in devices where space is a significant constraint. The voice coil motor includes a first coil portion intersectable with a magnetic field to produce resultant forces and a second coil portion shielded from the magnetic field such that the second coil portion does not intersect with the magnetic field. The voice coil may be adapted for rotation about an axis of rotation, with the magnetic field directed substantially parallel to the axis of rotation. An intervening pole piece between the first coil portion and the second coil portion may be used to shield the second coil portion from the magnetic field. The voice coil motor can thus be build to a narrower width while enabling a larger maximum stroke.

The present invention can be implemented as part of an actuator assembly, or as part of a data storage device.

These and various other features as well as advantages which characterize the present invention will be apparent upon reading of the following detailed description and review of the associated drawings.

### BRIEF DESCRIPTION OF THE DRAWINGS

FIG. 1 is a perspective view of a disc drive.

FIG. 2 is a perspective view of a voice coil motor according to one embodiment of the present invention.

FIG. 3 is a schematic diagram of the voice coil motor of FIG. 2.

FIG. 4 is a schematic diagram of a voice coil motor according to an alternate embodiment of the present invention.

FIG. 5 is a schematic diagram of a voice coil motor according to yet another embodiment of the present invention.

FIG. 6 is a perspective view of a voice coil motor according to another embodiment of the present invention.

### DETAILED DESCRIPTION

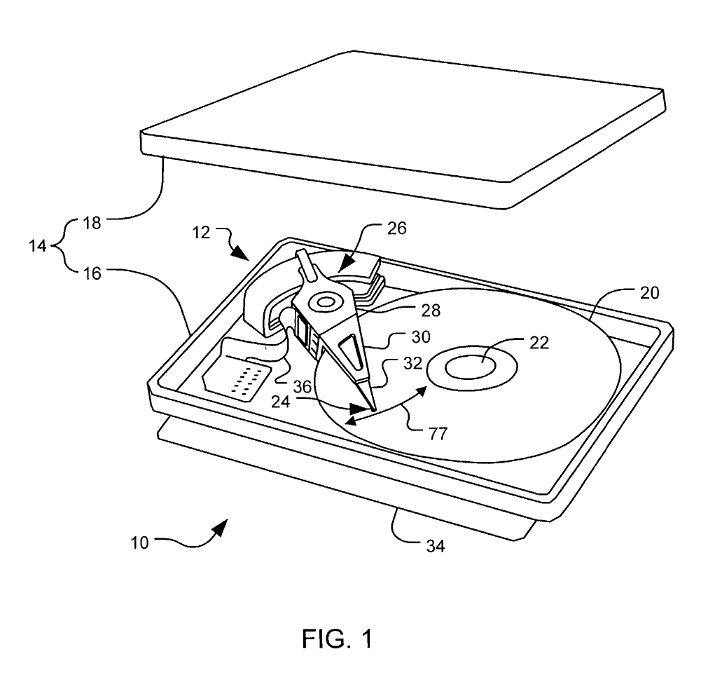

The disc drive 10 illustrated in FIG. 1 is one example of a data storage device in which a voice coil motor 12 of the present invention is applied. Provided within a protective housing 14, which may comprise a base 16 and a complementary cover 18, are storage media and apparatus for storing and retrieving data from the storage media. In this example, storage media is provided in the form of one or more discs 20. Each disc 20 is secured to a spindle motor 22, forming a disc stack assembly that is rotatably mounted to the base 16. Read/write heads 24 are supported by an actuator 26 so that they can be brought into proximity to a corresponding disc surface at various desired radial locations during drive operations. The actuator 26 may include a body 28 pivotably mounted to the base 16 and one or more actuator arms 30 extending from the body 28. Each actuator arm 30 is joined to one or more suspensions 32 from which the read/write heads 24 are supported. Extending substantially diametrically from the actuator arms 30 is a movable part of a voice coil motor. The remaining part of the voice coil motor is mounted to the base 16 or cover 18. Circuitry required for drive operations is generally located on a printed circuit board assembly 34 attached to an underside of the base. Within the protective housing 14, flex circuits 36 are used to accommodate moving components such as the actuator 26.

Following the trend of increasingly smaller consumer electronic devices, there is a desire to reduce the size of data storage devices such as disc drives. As can be seen from the brief description provided above of an exemplary disc drive, there is limited space within the protective housing for the various components. In such applications, a voice coil motor fashioned according to one embodiment of the present invention can be particularly useful as it requires less space while providing comparable or improved torque in comparison with conventional voice coil motors.

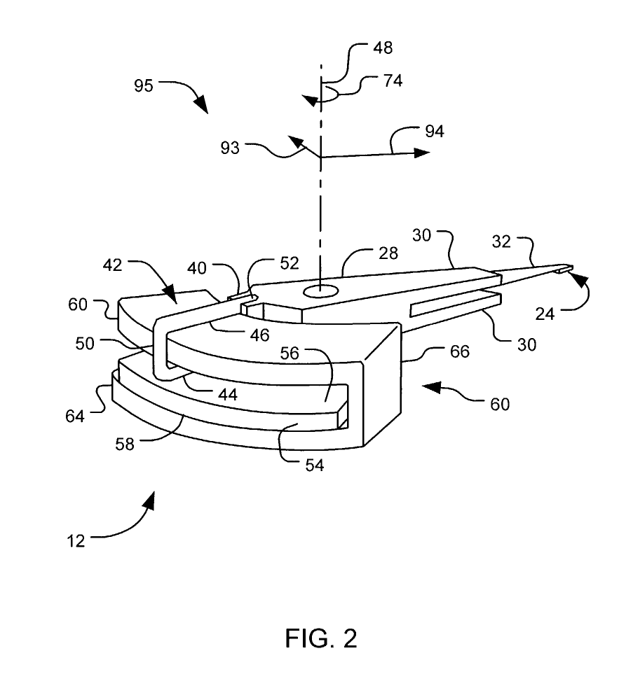

A voice coil motor 12 according to one embodiment of the present invention is shown in FIG. 2. A support 40 extends from the body 28 of the actuator in a direction substantially diametric to the one or more actuator arms 30. The voice coil 42 is fixed to the support 40 such that it presents a first coil portion 44 and an opposing second coil portion 46 that is each substantially perpendicular to the axis of rotation 48 of the actuator. The first coil portion 44 and the second coil portion 46 are joined by a third coil portion 50 and an opposing fourth coil portion 52, each of which is substantially parallel to the axis of rotation 48 of the actuator.

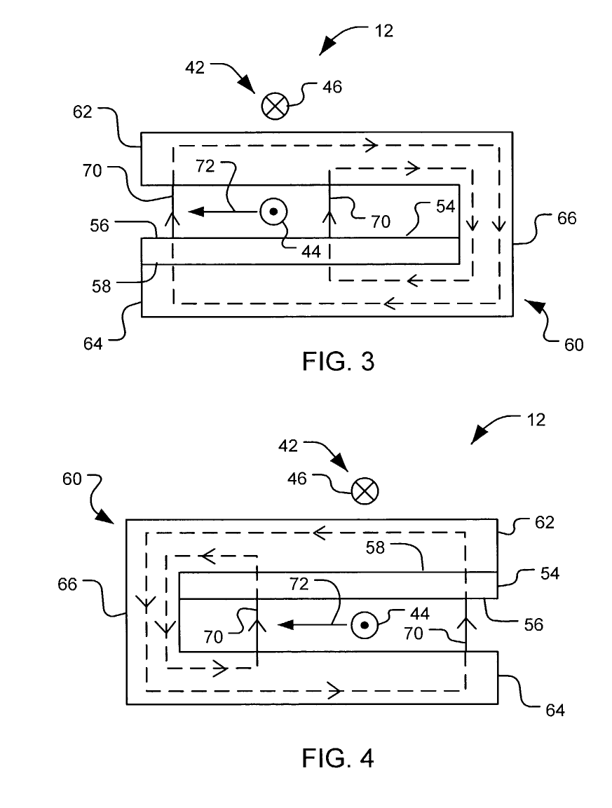

A permanent magnet 54 is disposed adjacent the first coil portion 44 such that it presents a magnetic field having magnetic flux lines 70 (refer FIG. 3) substantially parallel to the axis of rotation 48 of the actuator. The magnet 54 may be arranged such that a first major surface 56 and an opposite second major surface 58 (refer FIG. 3) are of opposite poles and are substantially perpendicular to the axis of rotation 48 of the actuator.

A back-iron or yoke 60 of a magnetically soft material includes an intervening pole piece 62 disposed between the first coil portion 44 and the second coil portion 46 such that the second coil portion 46 is shielded from the magnetic field of the magnet 54. The yoke 60 is shaped to provide for closure of the magnetic flux lines 70. One embodiment provides for the yoke 60 to also include a peripheral pole piece 64 in a plane substantially perpendicular to the axis of rotation 48 of the actuator, next to the magnet 56, on a far side 58 of the magnet from the first coil portion 44. The yoke 60 may also include an intermediate portion 66 extending between the intervening pole piece 62 and the peripheral pole piece 64.

FIG. 3 provides a schematic diagram of the electromagnetic interactions enabled by the voice coil motor 12 of FIG. 2. The yoke 60 is shaped such that magnetic flux lines 70 extending from the first major surface 56 of the magnet and toward the first coil portion 44 may be directed along the intervening pole piece 62, along the intermediate portion 66, to the peripheral pole piece 64, and to the second major surface 58 of the magnet, thereby closing the magnetic flux lines 70. When a current is passed through the voice coil 42, magnetic flux lines 70 between the first major surface 56 of the magnet and the intervening pole piece 62 intersect the current passing through the first coil portion 44, and produces a force that results in motion of the voice coil 42 in a direction 72 perpendicular to the magnetic flux lines 70 and to the current in the first coil portion 44. As a result, the actuator 26 rotates about its axis of rotation 48 in a clockwise direction 74 (refer FIG. 2). To rotate the actuator 26 in the opposite direction, the direction of the current is reversed. It will be understood that the direction of the magnetic flux can be changed without going beyond the scope of the present invention.

FIG. 4 shows another embodiment of the present invention in which the magnet 54 is nearer the intervening pole piece 62 than the peripheral pole piece 64. In such an arrangement, the intervening pole piece 62 directs the magnetic flux lines 70 away from the second coil portion 46, thereby shielding the second coil portion 46 from the magnetic field produced by the magnet 54. The first coil portion 44 is disposed in the magnetic field of the magnet 54, and between the intervening pole piece 62 and the peripheral pole piece 64. An intermediate portion 66 is provided between and in abutment with the intervening pole piece 62 and the peripheral pole piece 64 to close the magnetic flux lines.

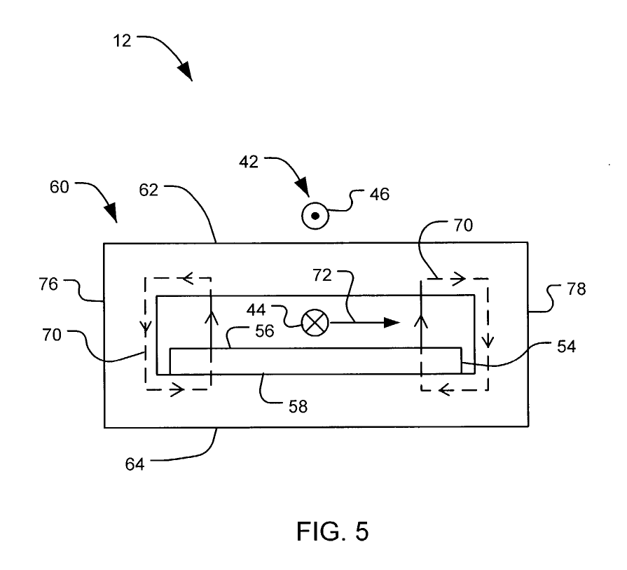

As illustrated by the embodiment of FIG. 3, the intermediate portion 66 may include only one end piece so as to reduce the materials or parts required, to simplify assembly, and to allow for a larger stroke 77 of the actuator. Alternatively, the intermediate portion 66 may include a first end piece 76 and a second end piece 78 disposed at both ends of the intervening pole piece 62 and of the peripheral pole piece 64, as shown in FIG. 5, such that yoke 60 may be described as a closed frame defining a slot 80 within which the first coil portion 44 is movable. The first end piece 76 and the second end piece 78 are spaced sufficiently apart to allow for the required stroke 77 (refer FIG. 1) of the actuator 26, where the stroke 77 refers to the maximum possible displacement of an actuator arm 30. It is found that a more uniform magnetic field can be achieved by using an intermediate portion 66 that is made up of more than one end piece, and thus makes for a more efficient voice coil motor.

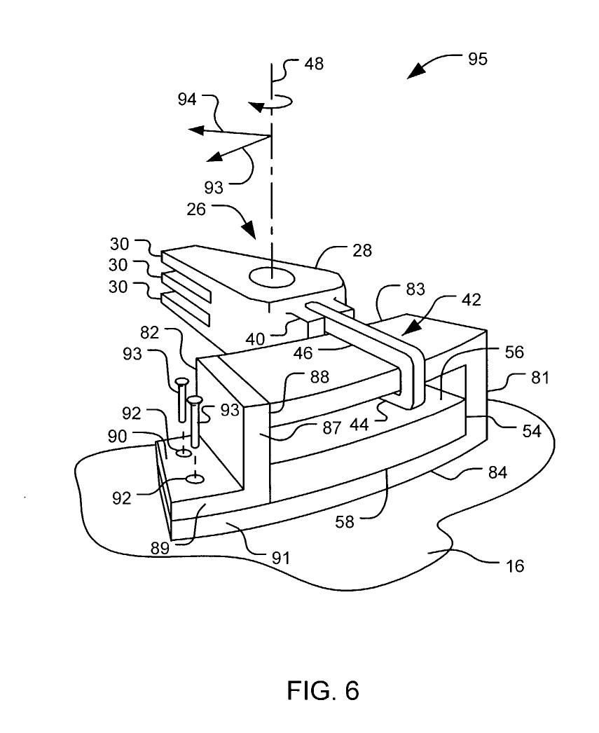

FIG. 6 shows another embodiment that has two spaced apart end pieces 81, 82 between the intervening pole piece 83 and the peripheral pole piece 84. The embodiment of FIG. 6 incorporates design-for-manufacturability features such as the provision of a flange 86 integral with one of the end pieces 81. In an exemplary assembly process, the intervening pole piece 83, a first end piece 81 and the peripheral pole piece 84 may be provided as an integral piece or as a pre-assembled component. The intervening pole piece 83 is threaded through the voice coil 42 before the second end piece 82 is assembled. The second end piece 82 includes an upright arm 87 having one or more inward surfaces 88 that are brought into abutment with the intervening pole piece 83. The second end piece 82 also includes a flange 89 extending at an angle with respect to the upright arm 87 such that in assembly, the flange 89 rests against the peripheral pole piece 84 with the flange 89 extending outwardly away from the voice coil 42. The flange 89 thus provides surface area 90 for attachment of the second end piece 82 to the peripheral pole piece 84. The peripheral pole piece 84 may be formed longer than the intervening pole piece 83 so as to provide an extension 91 suitable for mating with the flange 89. For example, the flange 89 may be provided with holes 92 that in assembly are aligned with threaded holes in the extension 91 of the peripheral pole piece. Fasteners 93 such as screws can thus be used to securely fix the second end piece 82 to the peripheral pole piece 84. The same fasteners 93 can also be used to secure the peripheral pole piece 84 to the base 16 by providing holes in the base 16 aligned with the holes in the peripheral pole piece 84. The configuration described in the foregoing is especially suited for top-down assembly and facilitates automated assembly and manufacture.

In one aspect, the number of turns in the voice coil 42 is increased for increased coil torque. Alternatively, a voice coil motor 12 according to one embodiment of the present invention has an increased number of turns in the voice coil 42 as compared to a conventional voice coil motor having the same length of wire. Such a voice coil motor 12 has improved performance characteristics because of the higher coil torque for substantially the same coil-resistance.

It is contemplated in the present invention that only one coil portion acts as an effective length of the voice coil in the electromagnetic interactions. Traditionally, such an arrangement where only one out of four or more substantial coil portions is effective would have been avoided in the belief that it is inefficient. However, contrary to expectations, it is found that for a voice coil motor fashioned according to one embodiment of the present invention, comparable performance of the voice coil motor can be achieved.

It is found that the mass moment of inertia of an actuator assembly 95 about the axis of rotation 48 of the actuator is smaller than that of existing actuator assemblies. (The term “actuator assembly” as used in this document refers generally to assemblies where the actuator 26 is coupled with other components, for example, with the voice coil 42.) In other words, it is found that an actuator 26 coupled to a voice coil motor 12 of the present invention has less tendency to exhibit pitch or yaw motion. Pitch can be understood to be rigid body rotation about an axis such as the y-axis 93 as shown in FIG. 2, and roll can be understood to be rigid body rotation about an axis such as the x-axis 94 as shown in FIG. 2. In this reference frame, the x-axis 94 and the y-axis 93 are perpendicular to the axis of rotation 48 of the actuator. An actuator assembly 95 of the present invention will therefore be particularly suited for applications where it would be desirable to have minimal exhibition of pitch or yaw motion.

The reliance on only one effective length provides for a voice coil motor that has decreased width and increased resultant motion, which makes the voice coil motor 12 of the present invention particularly suitable for use in a small form factor disc drive. In addition, because a smaller magnet 54 is needed, the overall cost of the voice coil motor 12 is significantly reduced. It is estimated that as much as a sixty percent reduction in magnetic material can be made while maintaining acceptable performance. Such a voice coil motor 12 is therefore also suitable for use in a low-cost disc drive. At the same time, because of the arrangement of the voice coil 42 with respect to the axis of rotation 48 of the actuator, the natural frequency of the actuator assembly will be higher than that of conventional systems. This is a characteristic that is desired because it eventually contributes to overall improved performance of the data storage device. It is also a desirable characteristic of the present invention in that it provides for a structurally simple and therefore easily manufactured and easily assembled actuator assembly without sacrificing functional advantages.

Alternately described, a first contemplated embodiment of the present invention includes a voice coil motor (such as 12) that has a magnet (such as 54) providing a magnetic field (such as 70), a voice coil (such as 42) having a first coil portion (such as 44) and an opposing second coil portion (such as 46), and a yoke (such as 60). While the first coil portion (such as 44) is disposed such that it intersects the magnetic field (such as 70), the yoke (such as 60) is adapted to shield the second coil portion (such as 46) from the magnetic field (such as 70) such that the second coil portion (such as 46) does not intersect the magnetic field (such as 70).

In one embodiment where the voice coil (such as 42) is adapted for rotation about an axis of rotation (such as 48), the magnetic field (such as 70) intersecting the first coil portion (such as 44) is substantially parallel to the axis of rotation (such as 48).

Various optional features may be incorporated. For example, the yoke (such as 60) may include an intervening pole piece (such as 62, 83) between the first coil portion (such as 44) and the second coil portion (such as 46). The yoke (such as 60) may further include a peripheral pole piece (such as 64, 84) such that the first coil portion (such as 44) is between the intervening pole piece (such as 62, 83) and the peripheral pole piece (such as 64, 84). The yoke (such as 60) may also include a first end piece (such as 66, 76, 78, 81, 82) extending from the intervening pole piece (such as 62, 83) to the peripheral pole piece (such as 64, 84). Optionally, the yoke (such as 60) may include a second end piece (such as 66, 76, 78, 81, 82) extending from the intervening pole piece (such as 62, 83) to the peripheral pole piece (such as 64, 84), such that the first end piece (such as 66, 76, 78, 81, 82) and the second end piece (such as 66, 76, 78, 81, 82) are spaced apart.

In another embodiment, there is provided an actuator assembly (such as 95) having a body (such as 28) pivotable about an axis of rotation (such as 48), at least one actuator arm (such as 30) extending from the body (such as 28), and the voice coil motor (such as 12) operably coupled to the body (such as 28) at a position substantially diametrically from the at least one actuator arm (such as 30). The actuator assembly (such as 95) is configured such that the magnetic field (such as 70) intersecting the first coil portion (such as 44) is substantially parallel to the axis of rotation (such as 48).

In yet another embodiment, there is provided a data storage device (such as 10) having a housing (such as 14), storage media (such as 20) rotatably mounted to the housing (such as 14), an actuator (such as 26) rotatably mounted to the housing (such as 14), read/write devices (such as 24) supportable by the actuator (such as 26) in an operable relationship with the storage media (such as 20), and the voice coil motor (such as 12) operably coupled to the actuator (such as 26).

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, it will be understood that the voice coil need not necessarily be substantially rectangular in shape, and the first coil portion and the second coil portion need not be parallel to each other. Further, it will be appreciated by those skilled in the art that the various components of the voice coil motor may be oriented or shaped differently without departing from the scope of the present invention.

What is claimed is:

1. A voice coil motor comprising:
a magnet providing a magnetic field;
a voice coil having a first coil portion and an opposing second coil portion, the first coil portion intersecting the magnetic field; and
a yoke adapted to shield the second coil portion from the magnetic field such that the second coil portion does not intersect the magnetic field.

2. The voice coil motor of claim 1 in which the voice coil is adapted for rotation about an axis of rotation, and in which the magnetic field intersecting the first coil portion is substantially parallel to the axis.

3. The voice coil motor of claim 1 in which the yoke includes an intervening pole piece between the first coil portion and the second coil portion.

4. The voice coil motor of claim 3 in which the yoke further includes a peripheral pole piece, and in which the first coil portion is between the intervening pole piece and the peripheral pole piece.

5. The voice coil motor of claim 4 in which the yoke further includes a first end piece extending from the intervening pole piece to the peripheral pole piece.

6. The voice coil motor of claim 5 in which the yoke further includes a second end piece extending from the intervening pole piece to the peripheral pole piece, and in which the first end piece and the second end piece are spaced apart.

7. The voice coil motor of claim 6 in which a selected one of the first end piece and the second end piece further includes a flange extending away from the voice coil and mateable with the peripheral pole piece.

8. An actuator assembly comprising:
a body pivotable about an axis of rotation;
at least one actuator arm extending from the body; and
the voice coil motor of claim 1 operably coupled to the body at a position substantially diametrically from the at least one actuator arm.

9. The actuator assembly of claim 8 in which the magnetic field intersecting the first coil portion is substantially parallel to the axis of rotation.

10. The actuator assembly of claim 8 in which the voice coil defines a plane substantially parallel to the axis of rotation.

11. A data storage device comprising:
a housing;
storage media rotatably mounted to the housing;
an actuator rotatably mounted to the housing;
read/write devices supportable by the actuator in an operable relationship with the storage media; and
a voice coil motor of claim 1 operably coupled to the actuator.

12. A data storage device comprising:
storage media;
an actuator assembly;
read/write devices supportable by the actuator assembly; and
means for rotating the actuator assembly so that the read/write devices are positionable relative to the storage media.

13. The data storage device of claim 12 in which the means for rotating the actuator assembly comprises no more than one effective length of current conductor adapted for operable interaction with a magnetic field.
